(19) United States
(12) Patent Application Publication
(10) Pub. No.: US 2007/0264406 A1
(43) Pub. Date: Nov. 15, 2007

(54) SHELF STABLE MOUSSE

(76) Inventors: Ernst Beutler, Langnau (CH); Marlou Basco Constantino, South Jakarta (ID)

Correspondence Address: WINSTON & STRAWN LLP;PATENT DEPARTMENT, 1700 K STREET, N.W., WASHINGTON, DC, 20006, US

(21) Appl. No.: 11/764,707

(22) Filed: Jun. 18, 2007

Related U.S. Application Data
(63) Continuation of application No. PCT/EP05/56702, filed on Dec. 12, 2005.

(30) Foreign Application Priority Data
Dec. 21, 2004 (EP) EP 04030377.8

(51) Int. Cl. A23L 1/00

(52) U.S. Cl. 426/564

(57) ABSTRACT

The invention concerns a shelf stable mousse that is a food composition based on sweetened condensed milk which is aerated with an inert gas. The food composition contains a foam stabilizer, for example a hydrocolloid, and has a fat content of less than 25% by weight.

### CROSS-REFERENCE TO RELATED APPLICATIONS

This application is a continuation of International application PCT/EP2005/056702 filed Dec. 12, 2005, the entire content of which is expressly incorporated herein by reference thereto.

### FIELD OF THE INVENTION

This invention relates to a food product and more particularly to a shelf stable mousse, i.e., a mousse which does not need to be stored in a refrigerated environment, typically at room temperature and up to 30° C. The invention relates also to a method for manufacturing such a product.

### BACKGROUND OF THE INVENTION

EP 0827693 (U.S. Pat. No. 5,962,059) describes an aerated lactic protein and crystallized fat food product and its preparation. In the method according to EP 0827693, sweetened condensed milk and a lipid phase are mixed in a vat to obtain a pumpable liquid, then the mixture is pumped into heat exchanger while at the same time being kneaded. Subsequently nitrogen is injected in the mixture to form the mousse. The fat content is between 30 and 60%. The mousse is based on an oil in water emulsion and the air bubbles of the mousse are held by the fat. This requires a composition with high fat content typically a solid fat content greater than 8% at 30° C., otherwise, the air bubbles do not form or collapse rapidly or oil droplets form on top of the products. EP 0827693 is therefore not suitable for producing lighter type product, i.e., having fat content lower than 30%, as there would not be enough fat to stabilize the bubble structure creating the mousse.

U.S. Pat. No. 4,631,196 discloses a low calorie dairy product in form of a mousse which contains fructose and polydextrose which cannot be considered as regular sweetened condensed milk. Moreover the presence of fructose and polydextrose in the mousse leads to Maillard reactions and causes a browning of the mousse, which one wants to avoid.

U.S. Pat. No. 4,818,554 discloses a milk food product in the form of a foam obtained by whipping air or gas into it. This foamed product contains raw milk which has been subjected to reduced pressure evaporation plus preserving agents, gellifying agents, flavoring agents and foaming agents. This document uses glucose as sweetener which causes a Maillard reaction and leads to a brown product. Moreover the water activity is below 0.8. This document also uses albumin as a foaming agent which can bring in some risk of salmonella.

DE 3502967 discloses a dessert mousse powder mix which, once mixed with skimmed milk, is not shelf stable because of its high water content.

U.S. Pat. No. 5,614,243 discloses a starch-based texturing agent mixed in particular with skimmed milk, used in a low fat mousse which is not shelf stable because of its high water content.

EP 0937409 discloses a non-gelled and whipped refrigerated product which is not shelf stable.

Thus, there is a need in the art for improved mousse products that are shelf stable and that have a low fat content. These are now provided by the present invention.

### SUMMARY OF THE INVENTION

The present invention overcomes the aforementioned drawbacks by providing a shelf stable mousse having a low fat content. The invention also relates to provide a method for manufacturing a shelf stable mousse.

A shelf stable mousse according to the invention typically comprises a food composition based on sweetened condensed milk aerated with an inert gas, wherein the food composition contains a foam stabilizer and has a fat content of less than 25% by weight. In a preferred embodiment an emulsifier is added to the food composition.

In a preferred process according to the invention for the preparation of a shelf stable mousse based on sweetened condensed milk, a foam stabilizer, an edible fat and water are mixed and heated to form an emulsion, the emulsion is mixed with sweetened condensed milk in an in-line mixer to form a food composition, an inert gas is injected to aerate the food composition and the aerated composition is filled into a container and sealed.

### DETAILED DESCRIPTION OF THE PREFERRED EMBODIMENTS

The sweetened condensed milk generally has a water content of 15 to 30% by weight, preferably 25 to 28%. The sugar content of the sweetened condensed milk is preferably from about 60% by weight sugar in water up to the solubility of sugar in water. which is about 65% by weight in water. In the context of the invention the term sugar is considered in its general accepted meaning, i.e., sucrose. Sucrose is used in the mousse of the invention as main sweetener. Of course in certain cases the sucrose can be combined with artificial sugars in order to lower the sugar content of the mousse. The fat content of the sweetened condensed milk is generally 0 to 20% fat by weight, preferably 5 to 10%. The content of fat which is solid at a given temperature is not important in the present invention.

The sweetened condensed milk preferably has a water activity (defined as the ratio of the water vapor pressure over a food to that over pure water) of lower than 0.86, most preferably between 0.80 and 0.85. If the mousse composition has a water activity value lower than 0.86, the need to use expensive aseptic filling installation is eliminated. The standard filling technique valid for condensed milk can be used.

The foam stabilizer is preferably a hydrocolloid. The hydrocolloid stabilizes the gas bubbles of the mousse against collapse on storage. Examples of preferred hydrocolloids are polysaccharides such as xanthan gum, alginate or a cellulose ether such as sodium carboxymethylcellulose. Xanthan gum, which is sold for example under the Trade Mark ‘Keltrol F’, tends to increase the elasticity of the mousse. Alginate tends to increase the firmness of the mousse. Sodium carboxymethylcellulose (Na—CMC), sold for example under the Trade Mark ‘Blanose’, is particularly good at stabilizing the mousse. Mixtures of hydrocolloid foam stabilizers can be used, for example xanthan gum with Na—CMC or xanthan gum with alginate. The hydrocolloid content of the food composition is preferably between 0.1 and 2% by weight, most preferably in the range 0.8 to 1.5%. Other examples of stabilizers include carrageenan, guar gum, gum arabic, locust bean gum, aribinogalactan, gellan gum, agar-agar, furcellaran, alginate, gelatin, starch, cellulose, modified cellulose, carboxymethyl cellulose, methyl cellulose, hydroxypropyl cellulose hydrocolloids, and the like. Preferably the mousse will be free of gelatin.

The emulsifier is preferably a mono- or di-glyceride, that is to say a monoester and/or di-ester of glycerol with a fatty acid. Mixtures of mono- and di-glycerides are often preferred, for example the product sold under the Trade Mark ‘Cremodan Super’. Such glycerol partial ester emulsifiers usually have a melting point of above ambient temperature, for example between 30° C. and 100° C. Use of emulsifiers with such a melting point may aid in stabilizing the mousse. An alternative emulsifier is lecithin. The food composition generally has an emulsifier content of between 0.2 and 3% by weight, preferably 0.4 to 1.0%, and most preferably about 0.6 to 0.7%. Other examples of emulsifiers include: hydroxylated lecithin, fractionated lecithin, polysorbate, sodium stearyl lactylate, calcium stearyl lactylate, hexaglycal distearyte, and the like.

It will also be noted that some stabilizers having certain emulsifying properties can also be advantageously used in the mousse preparation mixture.

Other known food ingredients can be included in the food composition, for example flavors such as fruit flavors, chocolate, vanilla or dolce de leite. A food acid such as citric acid or lactic acid can be used in conjunction with fruit flavors. We have found that such an acid improves the mousse foam structure as well as the taste.

In the preferred process according to the invention for preparation of the shelf stable mousse, the foam stabilizer, the emulsifier, an edible fat and water are mixed and heated to form an emulsion which is then mixed with sweetened condensed milk (SCM) in an in-line mixer. The process of EP 0827693 can not readily be used to produce the mousse of the present invention, as the water content of the mixture activates the hydrocolloid stabilizer, forming a mixture which is too viscous to be pumped. The foam stabilizer, the emulsifier, the edible fat and water can be mixed and then heated to form an emulsion, or separate ingredients or mixtures of less than all the ingredients can be heated and then mixed, or the ingredients can be mixed and heated simultaneously, for example in an in-line mixer. Flavors can additionally be added to the mixture The mixture of foam stabilizer, emulsifier, edible fat and water is preferably heated to a temperature above the melting point of the emulsifier and above the melting point of the edible fat, most preferably to a temperature in the range 75 to 100° C., for example about 85° C.

The edible fat preferably comprises a dairy fat such as anhydrous butter oil used alone or mixed with another edible fat or oil. We have found that a mix of stabilizers, emulsifiers and water is more viscous and more difficult to handle than a mixture which additionally contains fat and is emulsified.

The SCM and the emulsion of foam stabilizer, emulsifier, edible fat and water are preferably each pumped individually by means of a positive displacement pump and then mixed in an in-line mixer, for example a static in-line mixer or an in-line dynamic mixer such as a centrifugal pump or rotor and stator device. One or more mixing steps can be used at this stage. For example the SCM and emulsion can be mixed in an in-line mixer and then in a homogenizer which reduces the particle size of the disperse phase of the emulsion, which may further improve the stability of the mousse The homogenizer, which is preferably in-line, can for example operate at a pressure setting of 200 to 500 bar.

The food composition preferably has a holding time between mixing and aeration to allow the thickening reaction of the hydrocolloid foam stabilizer to start. The holding time can for example be of 1 to 5 minutes. In a continuous process, such a holding process can be achieved by passing the food composition though a pipe, for example a 25 mm diameter pipe, in which it is not subject to any substantial shear.

The inert gas is then injected to aerate the food composition, generally in conjunction with whipping the mixture. Whipping is a further mixing step to disperse the nitrogen as small bubbles throughout the composition, thereby forming an aerated composition which can set to a mousse. The inert gas used to aerate the food composition is preferably nitrogen. Sufficient gas is used to give the mousse a density in the range 200 to 100 g/l, preferably 400 to 600 g/l.

The aerated composition is filled into a container, preferably before the mousse has set, and the container is closed and sealed. The container can for example be a can or a plastic cup of the type known for mousse or yoghurt products. The container or the packaging surrounding it should be rigid enough to protect the foam structure. The filling process is preferably a clean filling operation in an environment with clean filtered air, as used for filling SCM. Mousse filled in cans by such a process can have a shelf life of 9 months.

### EXAMPLES

The invention is illustrated by the following Examples, in which percentages are by weight.

### Example 1

Standard sweetened condensed milk of water content 26% and fat content 7% is used as base product and put in a storage tank at 20-25° C. prior to inline mixing.

In a separate vessel equipped with a high shear mixer, a blend of 400 g Xanthan gum (Keltrol F); 1.6 kg mixed mono- and di-glyceride esters (Cremodan Super); 5.6 kg of anhydrous butter oil and 400 g water is heated to a temperature of more than 80° C. by means of heating the vessel with hot-water circulation over the double jacket to form a stabilizing blend.

The two components are then pumped individually by means of a positive displacement pump (eccentric screw pump sold under the Trade Mark ‘Mono’) in a proportional feed rate. The main stream of sweetened condensed milk is fed at a flow rate of 80 liters per hour whereas the flow rate for the stabilizing blend is fixed at 3.5 liters per hour. The two components meet in the piping system and are then continuously mixed by means of a static inline-mixer followed by an inline homogenizer with pressure setting at 350 bar. After mixing and homogenizing, the food composition is held for a time of 1 to 5 minutes by pumping the product through a 25 mm diameter holding tube before its arrival at the aeration station.

In the aeration station nitrogen is injected into the product at the rate of 2.7 liters/minute. After that the product passes through a mixing head (Hansa mixer) followed by pressure equalization in another holding tube of 25 mm diameter. The aerated product is then filled into cans and sealed on a filling machine conventionally used for SCM.

A homogenous, smooth mousse was obtained with the following characteristics:

| | |
|---|---|
| Dry matter content | 73.94% |
| pH | 6.3 |
| Water activity (aW) | 0.83 |
| Fat content (lactic fat) | 10% |
| Protein content | 7.1% |
| Volumetric mass | 500 gram/liter |
| Texture and consistency | Smooth, frothy and slightly sticky |

### Examples 2 & 3

The process of Example 1 was repeated using the stabilizing blends described in the following compositions. In each Example the stabilizing blend was dosed in the same proportion to the sweetened condensed milk as under Example 1.

### Example 2

The stabilizing blend consists of 2 kg Alginate (Protanal DP 5340); 1.6 kg Cremodan Super; 4 kg anhydrous butter oil and 400 g. water.

The mousse produced had similar characteristics to the mousse of Example 1 but a somewhat firmer texture.

### Example 3

The stabilizing blend consists of 150 g. Xanthan gum (Keltrol F); 105 g. sodium carboxymethylcellulose (Blanose); 600 g. Cremodan Super; 1.8 kg anhydrous butter oil and 300 g water.

The mousse produced had similar characteristics to the mousse of Example 1 but a somewhat stickier or softer texture.

What is claimed is:

1. A shelf stable mousse comprising a food composition based on sweetened condensed milk aerated with an inert gas, characterized in that the food composition contains a foam stabilizer and has a fat content of less than 25% by weight.

2. The mousse according to claim 1, wherein the mousse contains sucrose as main sweetener.

3. The mousse according to claim 1, wherein the mousse is free of gelatin.

4. The mousse according to claim 1, containing at least 60% sugar in water.

5. The mousse according to claim 1, wherein the fat content is present in an amount of up to 20%.

6. The mousse according to claim 1, wherein the fat content is between 5 and 10% by weight.

7. The mousse according to claim 1, wherein the food composition has a water activity value lower than 0.86.

8. The mousse according to claim 1, wherein the foam stabilizer is a hydrocolloid.

9. The mousse according to claim 7, wherein the hydrocolloid comprises xanthan gum.

10. The mousse according to claim 7, wherein the hydrocolloid comprises an alginate.

11. The mousse according to claim 7, wherein the hydrocolloid comprises sodium carboxymethylcellulose.

12. The mousse according to claim 7, wherein the hydrocolloid is present in an amount of 0.1 to 2.0% by weight of the food composition.

13. The mousse according to claim 1, which further comprises an emulsifier.

14. The mousse according to claim 13, wherein the emulsifier is a mono- and/or di-ester of glycerol with a fatty acid.

15. The mousse according to claim 13, wherein the emulsifier is a mixture of mono- and di-glycerides.

16. The mousse according to claim 14, wherein the emulsifier has a melting point between 30° C. and 100° C.

17. The mousse according to claim 13, wherein the emulsifier is present at 0.2 to 3.0% by weight of the food composition.

18. A process for the preparation of a shelf stable mousse based on sweetened condensed milk, which comprises mixing and heating a foam stabilizer, an edible fat and water to form an emulsion, mixing the emulsion with sweetened condensed milk in an in-line mixer to form a food composition, and injecting an inert gas to aerate the food composition and form the mousse.

19. The process according to claim 18, which further comprises filling and sealing the aerated composition into a container.

20. The process according to claim 18, wherein the foam stabilizer is present at 0.1 to 2.0% by weight of the food composition, the edible fat is present at 1.0 to 5.0% by weight of the food composition, and the water is used at 2 to 20% based on the total weight of foam stabilizer, emulsifier and edible fat.

21. The process according to claim 18, wherein the emulsion is mixed with the sweetened condensed milk in an in-line mixer and then homogenized.

22. The process according to claim 18, wherein after the emulsion is mixed with the sweetened condensed milk, the resulting food composition is held under conditions in which it is not subject to any substantial shear before it is aerated.

23. The process according to claim 18, which further comprises an emulsifier.

24. The process according to claim 18, wherein the emulsifier is present in an amount of 0.2 to 3.0% by weight of the food composition.
